(19) United States
(12) Patent Application Publication
(10) Pub. No.: US 2026/0049677 A1
(43) Pub. Date: Feb. 19, 2026

(54) ASYMMETRIC WEDGE THREAD TUBULAR CONNECTION OPTIMIZED FOR PRESSURE AND TORQUE CONTROL

(71) Applicant: Multi Helix Consulting Corp. Inc., Montgomery, TX (US)

(72) Inventors: Kris L. CHURCH, Montgomery, TX (US); Luigi LICITRA, Spring, TX (US)

(73) Assignee: Multi Helix Consulting Corp. Inc., Montgomery, TX (US)

(21) Appl. No.: 19/369,876

(22) Filed: Oct. 27, 2025

Related U.S. Application Data
(62) Division of application No. 17/972,068, filed on Oct. 24, 2022.
(60) Provisional application No. 63/274,081, filed on Nov. 1, 2021.

(51) Int. Cl. F16L 15/06; F16L 15/00

(52) U.S. Cl. CPC F16L 15/06; F16L 15/001

(57) ABSTRACT

A threaded tubular connection which includes a pin member and a mating box member. The pin member has pin threads with stab flanks and load flanks and thread crests and thread roots which are adapted to be made-up with a mating box member having a complimentary thread structure. The threads of the pin member are intentionally made asymmetric to those of the box.

### CROSS-REFERENCE TO RELATED APPLICATIONS

The present application is a divisional application of Ser. No. 17/972,068, filed Oct. 24, 2022, entitled “Asymmetric Wedge Thread Tubular Connection Optimized For Pressure and Torque Control”, by the same inventors which, in turn, claimed priority from a previously filed provisional application, Ser. No. 63/274,081, filed Nov. 1, 2021, entitled “Asymmetric Wedge Thread Tubular Connection Optimized For Pressure and Torque Control”, by the same inventors.

### BACKGROUND OF THE INVENTION

### Field of the Invention

The present invention relates generally to thread forms of the type used for tubular connections, and, more specifically, to threaded connections useful for securing flow conduits to form a desired continuous flow path in oil and gas country tubular goods.

### Description of the Prior Art

A variety of specialized threaded connections are known in the prior art for joining flow conduits and other tubular members in an end-to-end relationship in secure fashion. For example, such threaded connections are used in pipe strings employed in the oil and gas industry for the production of hydrocarbons and other forms of energy from subsurface earth formations. Examples of such pipe strings include drill pipe, well casing and production tubing, known commonly as “oil country tubular goods” (OCTG). Pipe strings of this type are commonly used in today's hydraulic fracturing operations. While OCTG's are the primary intended use for the threaded connections of the invention, other applications for the threaded connections of the invention include other earth drilling and completion applications, for example, horizontal/trenchless drilling operations, such as those used to install fiber optic cable and other utilities, or non-oilfield applications associated with the construction industry. All of these type goods employ threaded connections of the type under consideration for connecting adjacent conduit sections or pipe joints.

In the case of oil field casing, tubing and drill pipe, it is a common practice to use metal pipes of a definite length, with sections of pipe joined to form a string. The string of pipe effectively creates one lengthier pipe, intended to provide a means to reach the depth at which the reservoirs of gas or oil are found in order to extract oil or gas reserves to the surface. The pipe sections are secured together at their ends by an externally threaded connector, or “pin” that is threadedly received within an internally threaded connector or “box”. Each pipe section typically has a pin on one pipe end and a box at the opposite pipe end. Some pipe has an internally threaded coupling secured to one end of a double pin pipe section to produce the box. The individual pipe sections are frequently referred to as a “pipe joint”.

In today's oil and gas industry, horizontal drilling and hydraulic fracturing in, for example, shale formations have become an integral part of the industry's portfolio of opportunities for increased oil and gas production. While hydraulic fracturing has become a more or less routine practice, operators in search of competitive advantages continuously push the limits of equipment and technology. Today's operators try to drill deeper, drill longer reach horizontal sections, drill faster and complete the wells faster. It is particularly difficult for tubing, casing and drill pipe connections to meet these increased performance properties, especially the thin wall tubulars, such as small diameter casing, used as the fracturing or “frac” strings, plus other drilling and completion connections.

These frac strings, which have to be installed to reach the fullest length of the well bore, even in the long reach, uncased drilled sections, must have the largest inside diameter and smallest outside diameter possible, yet maintaining the highest torque and fracturing pressure capabilities possible. Frac strings, since they are largely run inside uncased hole, are run as fast as possible, before the formation can collapse. These strings have to be in continuous rotation as they are pushed farther and farther into the uncased hole. In those situations where the bore hole becomes tight, friction on the rotating pipe can cause the torque on the connections to reach exceedingly high levels.

When it became clear to operators that standard industry connectors could not meet the requirements of this type of rigorous service, they quickly gravitated to the use of connectors having dovetail wedge threads, or variants thereof, as shown in the original wedge thread design by Thomas L. Blose (US Pat. RE. 30,647). These types of thread forms are sometimes referred to as “premium threaded connections”in the oil and gas industry.

The Blose wedge thread patents (e.g., US Pat. RE. 306,47) and others disclose a tubular connection having a thread form which provided an unusually strong connection while controlling the stress and strain in the connected pin and box members of the connection. Among other features of these designs, thread root and crest engagement before final assembly prevent premature makeup due to ovality. The first Blose thread forms featured mating helical threads which were tapered in thread width in opposite directions to provide wedge-like engagement of the opposing flanks to limit rotational make-up of the connection.

U.S. Pat. No. 4,600,224, issued Jul. 15, 1986 to Blose was a refinement and further improvement to the original basic wedge thread concept. In the invention disclosed in the '224 patent, a connection was shown having a “chevron” load flank. Radial make-up of the threaded connection was controlled by the special thread structuring where the radial movement of a thread into a mating thread groove was restricted by a chevron type interfit between two load bearing thread surfaces of the threaded connection instead of relying upon thread width alone.

U.S. Pat. No. RE 34,467 issued Dec. 7, 1992 to Doyle Reeves purported to be an improvement to the basic Blose wedge thread design. As explained by the patentee, when Blose's connection is rotatably made up to engage both the front and back thread load flanks, incompressible thread lubricant or other liquid may be trapped between the engaged load flanks. The invention described in Re. Pat. No. 34,467 purports to preclude the possibility of false indication of torque by excluding thread lubricant from between the thread load flanks that are brought into engagement at make-up. U.S. Pat. Nos. 6,254,146 and 6,722,706, to Kris L. Church, were directed to further improvements in thread forms of the type under consideration. The thread forms shown in these earlier Church patents include a special thread structuring where the radial movement of one thread into a mating thread groove is controlled by a complex profile interfit between the two mating thread surfaces of the threaded connection. The stab flanks complex profile is preferably a multi-faceted flank having at least three facets and four radii per stab flank. The pin thread crests have a crest width and the pin roots have a root width with the width of the crest being less than the width of the roots, which is exactly opposite that of the general dovetail design.

Some of these connections have included a gas resistant thread seal feature. In some cases, the gas seal feature was a metal-to-metal seal region incorporated into the pin and box members. Metal-to-metal seals of this general type are discussed, for example, in U.S. Pat. No. 6,254,146, issued Jul. 3, 2001, to Kris L. Church and in U.S. Pat. No. 6,832,789, issued to Kris L. Church. Other simpler designs also exist, for example, the traditional “API 8 Round Thread” is a “thread fit” seal which is screwed together with pipe dope to provide the sealing capability.

Wedge thread connections obtain their torque resistance from the axial squeeze of the threads themselves rather than the jackscrew effect of threads torquing against a separate torque shoulder. Such shoulders require an increase in the connection cross section which, in turn, increases the connection OD and/or decreases the connection ID.

Whereas typical wedge thread connectors are capable of achieving very high torque levels, much higher than standard (non-wedge thread) industry connectors, their assembly often leads to connections being made up with very high axial flank interferences in certain areas and little or no interference in other areas. This then leads to the compromise of pressure containment capabilities. Thus, despite the improvements in connection design discussed above, a need continues to exist for a threaded connection which can couple tubular pipe sections quickly and efficiently, and which forms a secure connection under a variety of conditions of use, including use in hydraulic fracturing operations.

Ideally, such a connection design, when used in such environments as horizontal drilling and hydraulic fracturing in shale formations, would allow the operator to drill deeper, drill longer to reach horizontal sections and to drill faster and consequently complete wells faster.

The forgoing needs and shortcomings of the prior art are met by the invention to be described in the sections which follow. The present invention which will be described is a further modification of the basic threaded connection design features discussed above which provides improved design characteristics and performance over the prior art and which meets the variously enumerated needs of the prior art discussed above.

### SUMMARY OF THE INVENTION

The thread form of the invention is intended for use in a tubular connection having a pin member adapted to be made up with a box member to form a pipe connection, the pin member having an exterior surface, an interior surface, a longitudinal axis, and an end face adjacent a mouth opening thereof. The pin member has pin threads with thread crests and thread roots which are adapted to be made up with a mating box member also having threads with thread crests and thread roots to form a secure connection. The pin threads extend from the outer face of the pin member inwardly in a longitudinal direction generally parallel or on a taper to the longitudinal axis of the pin member.

In the context of the present invention, the preferred tubular connection is a wedge thread tubular connection having stab and load thread flanks, as well as roots and crests, optimized in such a way that sufficient bearing loads are maintained on all thread surfaces throughout the length of the connection to hold rated pressure, especially sudden fracturing pressure, and make up within a broad torque range. This optimization is achieved by making the pin member asymmetric to the box member.

In traditional connection design, even in traditional wedge thread connection design, the pin, male members are traditionally made to be mirror images of the box, female members except for allowance for radial interference. In the present invention, pin members are intentionally designed to be asymmetric to the box members in the axial direction, as well as in the radial direction. This asymmetric orientation between mating members, often appearing to exceed the yield of the underlying material upon make-up of the connection, actually produces a made-up connection where the thread flanks, as well as the thread roots and crests, are optimized in such a way that sufficient bearing loads are maintained on all thread surfaces throughout the length of the connection and throughout the application of all loads in service.

In one preferred form, a wedge thread tubular connection is shown which can be used for well tubing, casing and drill pipe, which is capable of being screwed together to form a fluid tight seal.

The connection includes a pin member having a pin end with an outer extent and having external threads cut over a given thread length with stab flanks and load flanks and crests and roots, constituting a thread form for the pin member. The connection also includes a mating box member with a box end having internal threads cut over a given thread length with stab flanks and load flanks and crests and roots, constituting a thread form for the box member, for mating with the external threads of the pin member to make up the threaded connection. The thread form of the pin member is intentionally asymmetric to that of the box member, the pin thread form being offset in a thread axial direction by a predetermined amount, thereby allowing triaxial stresses in the connection to be minimized along an entire length of the threaded connection in use.

The thread offset is increased until triaxial stresses are minimized in the threads around a complete von Mises (VME) envelope for the connection, including a full VME loading cycle during a transition zone between horizontal and vertical, as tension with torque is replaced by compression with torque.

The pin and box threads are machined from a thread width reference point, and wherein FEA analysis is used to determine how to preload each thread form throughout its length in order to provide completely balanced and uniform triaxial stress in every portion of the thread, followed by changing the thread width reference point to effect these results.

Additional objects, features and advantages will be apparent from the written description which follows.

### BRIEF DESCRIPTION OF THE DRAWINGS

FIG. 1 is a side, quarter sectional view of the pin and box end of a prior art wedge thread connection which is believed to be representative of the present-day wedge thread design, showing the axial dimension thereof referenced from an origin position that is determined by the thread designer;

FIG. 2 is a quarter sectional view similar to FIG. 1, but showing the pin and box ends of a one-step connection featuring the asymmetric thread forms of the invention;

FIG. 3 is a view similar to FIG. 1 of the pin and box ends of another prior art connection, in this case, a two-step connection;

FIG. 4 is a view similar to FIG. 2 of another connection featuring the asymmetric thread form of the invention, in this case, a two-step connection;

FIGS. 5 and 6 are side, quarter sectional views of a prior art two-step and one-step threaded connections, respectively, where the pin and box members are shown in the made-up position illustrating the consistent and uniform load flank and stab flank engagement which is required throughout the thread region to maintain internal pressure;

FIG. 7 is a graphical representation of the vertical and horizontal sections of a typical well bore which is the subject of a hydraulic fracturing operation;

FIG. 8 is a graphical representation of VME envelope of the type which is analyzed and used in optimizing the amount of thread loading and bearing load in a threaded connection of the invention; and

FIGS. 9-12 are Finite Element Analysis (FEA) examples of symmetric, modified symmetric, and of the asymmetric wedge thread connection of the invention showing the von Mises stress as the connection progressed from the original design to the final design.

### DETAILED DESCRIPTION OF THE INVENTION

The present invention provides a unique type of threaded connection which meets the foregoing described objectives. The improved threaded connection of the invention will be described herein and the various features and advantageous details thereof are explained more fully with reference to the non-limiting examples which are illustrated in the Specification and in the accompanying drawings and detailed in the following description. Descriptions of well-known components and processes and manufacturing techniques are omitted so as to not unnecessarily obscure the workings of the invention. The examples used herein are intended merely to facilitate an understanding of ways in which the invention herein may be practiced and to further enable those of skill in the art to practice the invention. Accordingly, the examples should not be construed as limiting the scope of the claimed invention.

The thread forms of the invention can be used for making a threaded pipe connection capable of being screwed together and subsequently unscrewed and are well adapted for use as Oil Country Tubular Goods (OCTG) connections. The thread forms are used on a connection which includes a pin member having external threads with stab flanks and load flanks and crests and roots for mating with the mating internal threads of a box member to make up a pipe connection.

### I. Shortcomings Of The Existing Wedge Thread Technology

The shortcoming of the existing wedge thread technology will now be discussed and compared to the asymmetric thread designs of the invention. The connections using the thread forms of the invention are useful in meeting a variety of extreme sealing conditions. While the discussion which follows will center around hydraulic fracturing operations, it will be understood that the invention is not thus limited, but could be applied equally in other challenging sealing environments.

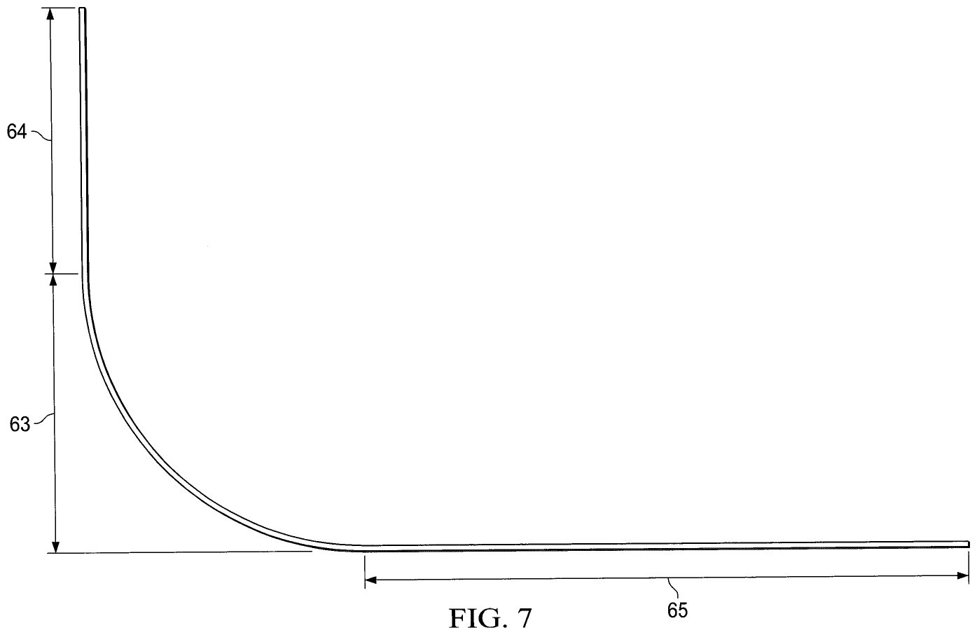

Leak resistance is especially important during hydraulic fracking operations. The most problematic area for pressure containment is in the well bore transition zone (shown as 63 in FIG. 7) between the vertical section (64 in FIG. 7) of the well and the horizontal section (65 in FIG. 7). It is in this transition zone that the tubular string will be at its greatest curvature. The resultant bending forces will tend to make the tube and connections ovalize and change the loading on the thread flanks. Rotation of the pipe in this transition zone adds the potential of damage from fatigue in the threaded area of the connection, as well as in other areas of the connection, especially in the critical cross section of the connection.

Typical prior art wedge thread connections, without optimized, asymmetric thread flank contact throughout their entire length, that are in or have gone through the transition zone, will likely be unable to withstand fracking pressures without leakage through the threads. Accordingly, for this service, many connection suppliers will add a metal-to-metal seal to their connections to contain the fracking pressures. Not only does this add cost, it adds complexity. Metal-to-metal seals have a very limited axial position of maximum engagement for pressure control. This feature also limits the available rotational torque range. Additionally, the metal-to-metal seals could become ovalized in the transition zone, thus losing their required fracturing sealing integrity. Also, if the wedge threads themselves make up further from the application of excess torque, they may become over made up and exceed the position of maximum leak resistance.

An additional consideration is the amount of axial compression applied to the tubular string, in conjunction with rotation, in order to force the tubular string to reach the furthest extent of the horizontal section of the well bore. Operators will tend to continue adding weight and torque on the string until the string advances as intended, pushing the connections to, and sometimes beyond, their limit. Traditional connections will typically fail by the nose of the pin yielding and curling into the ID of the connection. Wedge thread connections typically do not curl into the ID but rather just exceed their maximum make-up position and lose their ability to withstand subsequent frac pressure. However, wedge thread connections having asymmetric, optimized thread engagement as described herein, have an extremely high resistance to increased torque and typically lose no pressure-containing ability.

Another consideration is the high axial tension load that could be applied to the string in certain circumstances, one of which being when the string gets stuck in the horizontal section of the well and can neither be advanced further horizontally nor pulled back and out of the hole. In such an occurrence, the usual practice is to apply the highest possible tensile load to the string until the string starts moving. Unfortunately, that often leads to the connections becoming distorted and compromising their performance integrity.

Fortunately, however, wedge thread connectors having the asymmetric, optimized thread engagement as described herein, having an extremely high resistance to increased torque, can safely have moderately high tension applied to the string while ever increasing amounts of torque are applied until the string starts rotating. Once rotation has begun, friction resistance diminishes, thus allowing the string to be more easily withdrawn from the well bore.

### II. Genesis of Discovery of Asymmetric Wedge Thread Tubular Connection Optimized for Pressure and Torque Control

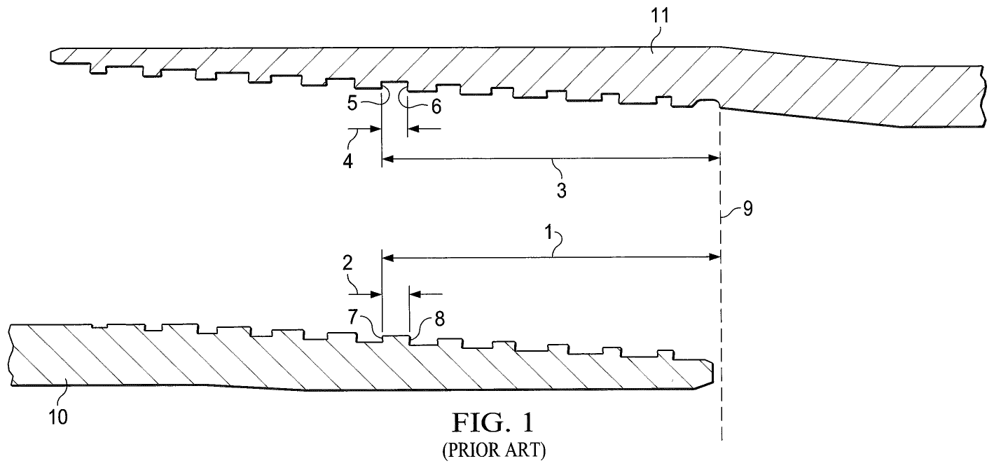

Helically tapered wedge threads, the most common form of wedge thread tubular connections, are manufactured by the passage of a threading insert over repeated passes along the length of the threads at one lead for the stab flank and a different lead for the load flank. The result is a wedge-shaped thread. The mating member uses the same stab and load flank leads. This allows the threads to be screwed together and then fully engage at a theoretical axial position. U.S. Pat. No. 6,270,127, to Enderle, is a typical example of such a prior art helically tapered wedge thread design. With reference to the prior art shown in FIG. 1 of the Enderle patent, the connection includes a pin member and a box member. The box member has a tapered, internal, generally dovetail-shaped thread structure formed thereon and adapted for engaging a complementary tapered, external, generally dovetail-shaped thread structure formed on pin member to mechanically secure the box and pin members in a releasable manner.

The internal thread form of the box member has stab flanks, load flanks, roots, and crests. The thread increases in width progressively at a uniform rate in one direction substantially the entire helical length of thread. The external thread of the pin member also has stab flanks, load flanks, roots, and crests. The thread increases in width progressively at a uniform rate in the other direction substantially the entire helical length of thread.

The Enderle reference is merely intended to be illustrative of a typical prior art wedge thread having pin threads which are symmetric with respect to the box threads. However, it also illustrates important differences in the prior art and the concepts of the the present invention. Enderle teaches how to lower the make-up torque of wedge threaded connections, particularly on very large diameter pipe where rig tongs often lack the torque capacity to fully make up a connection to where its thread flanks are fully engaged throughout their entire length. Basically, the teachings are related to the final made-up condition. Enderle teaches that at final make up there be sufficient clearances within the thread profile to cover different combinations of connector differences throughout the length of a single step or a two-step connection. However, Enderle does not teach or even infer that the gaps be closed throughout the thread profile over the entire length of the connection at final make-up, but with cyclic loading, the thread compound or coating used to plug the gaps between the threads can be squeezed out of the connection, allowing the connection to leak. Leaking connections are normally not allowed in service in the oil and gas industry. This position has been reinforced in recent years by more rigorous cyclic testing of connections being required before the connections are placed in service. In contrast, the teachings of the present invention address connection configurations in the machined state and in the final make-up condition, showing how to produce both uniform and reduced Von Mises stress throughout the length of the connection at final make up, where gaps have been eliminated.

Significantly, in the prior art connections, such as that shown in the Enderle reference, the connectors are designed to be symmetric in order to induce interference needed to produce torque and to hold internal pressure. That is, the box is a mirror image of the pin. In the connections of the invention, however, as will be described in detail, one of the connector members is intentionally made asymmetric with respect to the other connector member.

A well-known problem of wedge thread tubular connections, such as that shown in FIG. 1 of this application, as well as FIG. 1 of Enderle, is the difficulty of configuring them in such a way that the wedging thread forms mate with uniform bearing loads along their entire length. When wedge thread pin threads are mated with wedge thread box threads, axial bearing loads tend to be higher than desired at the start and at the end of the threads. When the wedging thread forms mate with non-uniform bearing loads, two problems occur. First, torque values required to make the connection up to any given axial reference point tend to vary wildly over the allowable torque range. This makes assembly and disassembly difficult and uncertain when the connections are run in service. Second, such connections, when run in service and subjected to combined loads approaching the design limits and transitioning around the von Mises Ellipse (VME), particularly when transitioning from tension to compression with internal pressure, the connections have a tendency to fail to hold rated pressure.

The “von Mises stress” is often used in determining whether an isotropic and ductile metal will yield when subjected to a complex loading condition. This is accomplished by calculating the von Mises stress and comparing it to the material's yield stress, which constitutes the von Mises Yield Criterion. The objective is to develop a yield criterion for ductile metals that works for any complex 3-D loading condition, regardless of the mix of normal and shear stresses. The von Mises stress does this by reducing the complex stress state down into a single scalar number that is compared to a metal's yield strength, also a single scalar numerical value determined from a uniaxial tension test on the material in a lab. It is an empirical process but works well for its intended purpose.

Because connection failure, whether analyzed according to von Mises criteria, or other criteria, is a well-known problem at the present time, operators needing totally reliable high-pressure service connections will require that their wedge thread connections all have metal-to-metal seals. However, adding a metal-to-metal seal to a wedge thread connector adds significantly to the cost to manufacture the connector. Also, because of the difficulty of controlling the exact axial make-up position of standard wedge thread connections (a requirement for metal-to-metal seals to function properly) the cost of manufacturing is higher than desired and the cost of properly running and testing these connections is higher than normal. For operators drilling in shale formations for oil and gas, where cost control is of paramount importance, running wedge threads is not attractive economically and would not be done except when the high torque capacity of wedge thread connections is absolutely required.

To better understand the problem of wedge thread tubular connections having inconsistent bearing loads along the entire length of each connector, the inventors used advanced Finite Element Analysis (FEA) techniques and triaxial analysis to determine how wedge threads load and unload along their entire threaded length as the connection is tested around the full limits of the VME. This analysis revealed that connections having uneven bearing loads across their entire threaded length will tend to open and close axially, and even radially, as the VME is circumnavigated. This open and close process, over time, tends to squeeze out of the connections the thread compound applied to lubricate the threads for make-and-break and to seal the threads for pressure control. Once the thread compound is gone, the connections become leak prone.

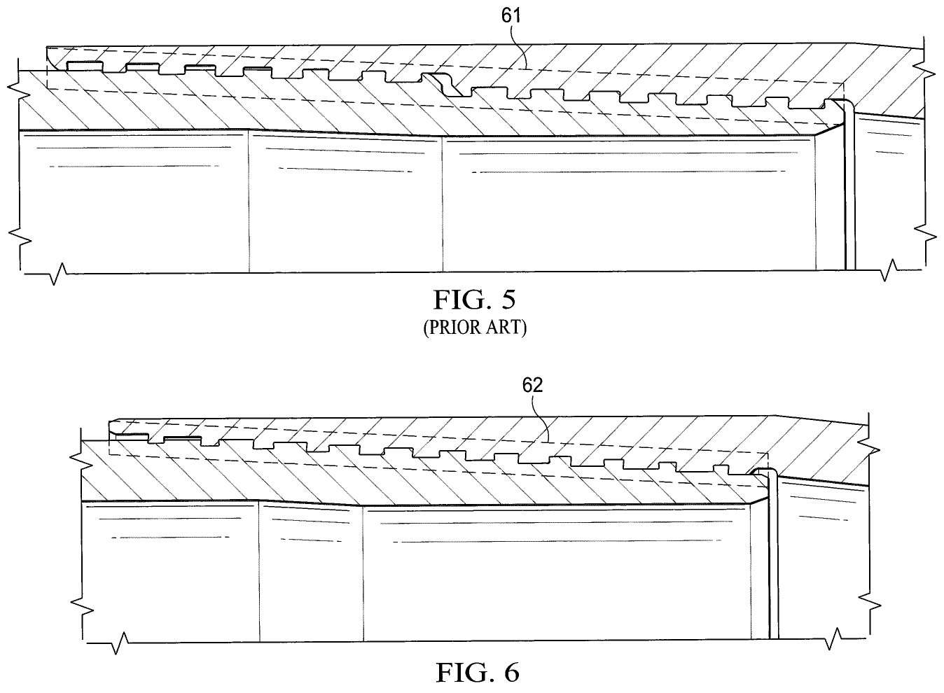

In order to quantify the magnitude of the loss of bearing load and opening along the length of the threads, the inventors used advanced FEA to manipulate the three triaxial (von Mises) stresses common to threaded tubular connections. These are axial (tension and compression—primarily from service and service pressure loading), radial (from make-up and service pressure loading), and hoop (primarily from make-up and service pressure loading). The three principal stresses can be designated as P1, P2, and P3. P1 is assigned to the highest stress, P2 to the next highest stress and P3 to the lowest stress. In their investigation, the inventors discovered that any male or pin connector that loses hoop compression at any point in the VME test envelope will open radially and possibly leak. Hoop compression is a function of diametrical thread interference configured at makeup and analyzed in the thread regions as shown in FIGS. 5 and 6. Accordingly, P1 would be hoop stresses. The lowest stress on makeup and in service is normally radial stress and is normally P3. Axial stress is normally P2.

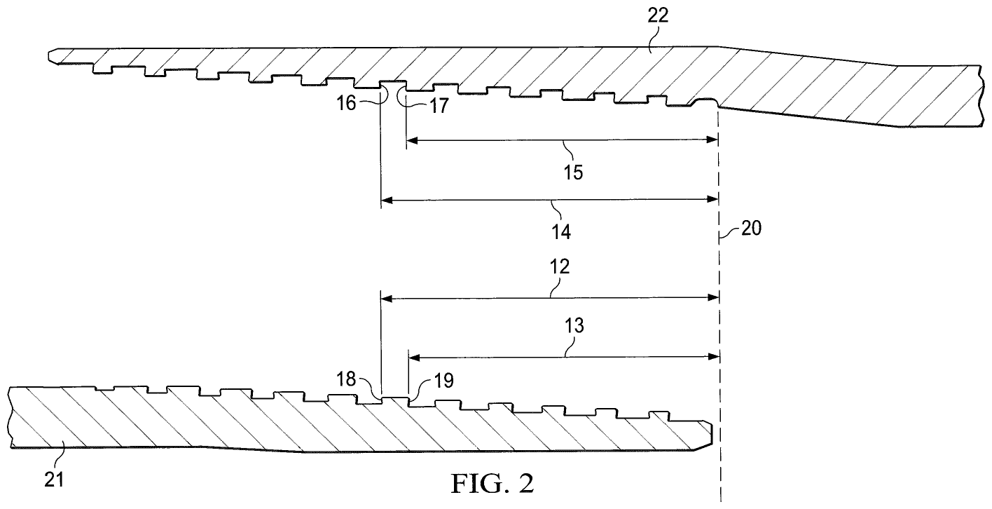

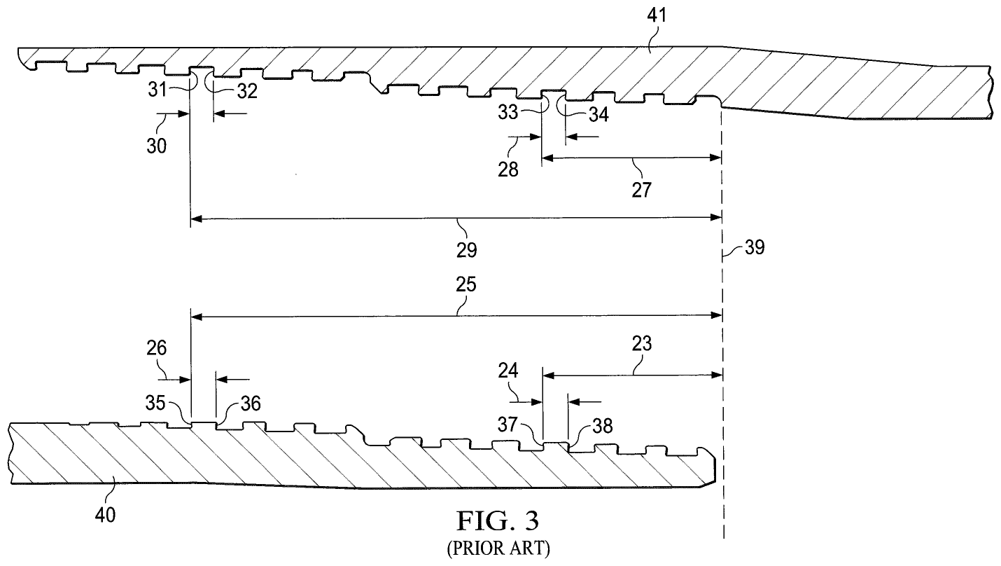

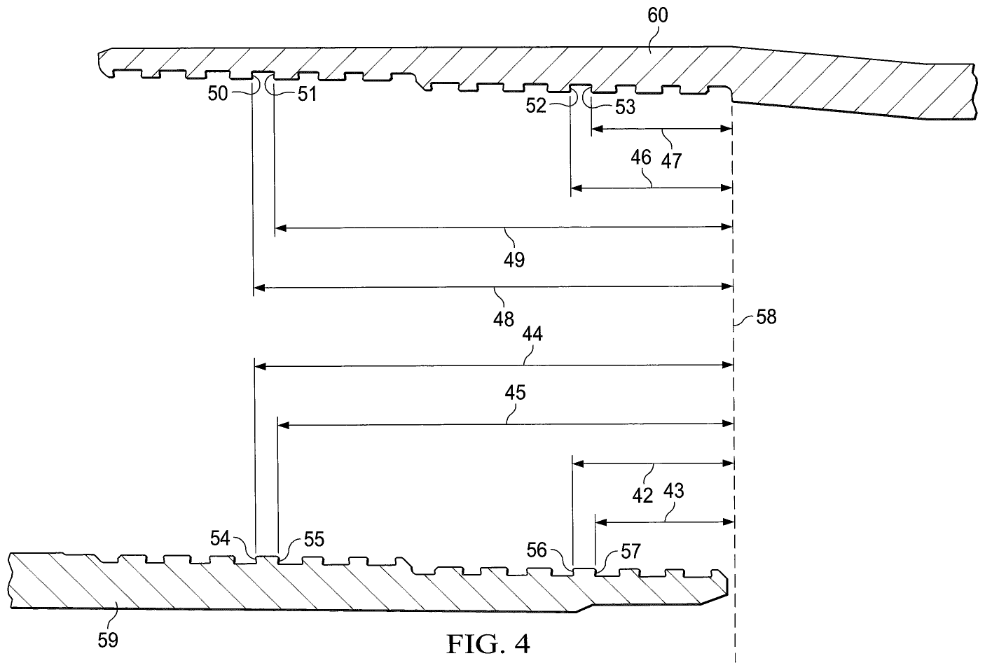

The inventors discovered in their investigation that changes in elasticity throughout the connection caused by the taper and changing wall thickness of the connection, and the distortions from Poisson's Effect, that connections made in this standard manner had threads that opened up under VME loading. Various methods of adjusting axial stress on each thread load and stab flank were explored until it was unexpectedly discovered that offsetting the thread flanks differently as shown in FIGS. 2 and 4 of the Drawings between the pin and box members by certain amounts could lead to more balanced loading at makeup and optimal loading in VME testing. This is in contrast to the typical symmetric configurations shown in FIGS. 1 and 3 that do not have uniform axial thread contact throughout the length of the connections.

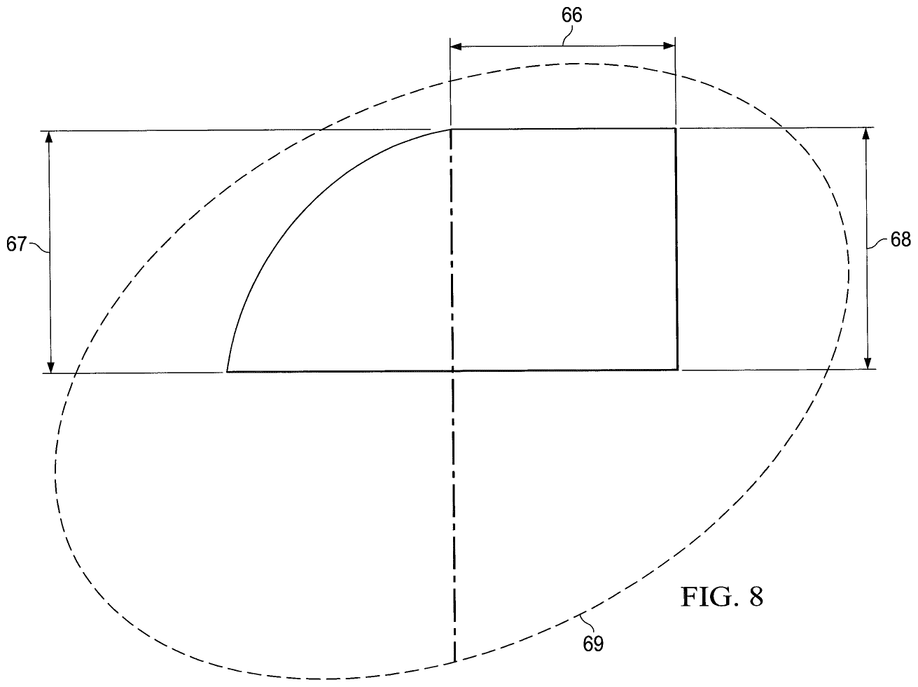

Since elasticity and the Poisson Effect vary throughout the assembled connectors, the amount of the offset and the resulting asymmetry has to be varied accordingly. For instance, the offset for the first step of a two-step connector will be different from the offset for the second step. Repetitive FEA is required to determine the amount of offset required on each step in order to optimize the amount of thread loading and bearing load present within the required VME envelope as shown as an example in FIG. 8.

Once the interference levels are set and once the offsets for each step are placed at their optimal setting, the connection makes up with precision to a given axial position and thereby withstands a very broad torque range. Then, by adjusting the amount of thread length engagement, the torque range can be set higher or lower for initial make up, allowing for accommodation of commonly used torque equipment while retaining exceptionally high torque capacity beyond that needed for normal operations. In fact, wedge thread connectors with asymmetric threaded sections optimized as described herein, hold full rated pressure within the established VME envelope, thus eliminating the need for a metal-to-metal seal in order to hold internal pressure.

### III. Examples of Normal Wedge Thread Configurations as Compared to the Unique, Asymmetric Improved Wedge Thread Configurations of the Invention

In triaxial stress analysis of threaded tubular connections, where P1 is commonly known as the highest principal stress, P2 the second highest principal stress and P3 the lowest principal stress, the three principal stresses (hoop, axial and radial) will sometimes switch between P1 and P2 but normally not between P1 and P3 or between P2 and P3, depending on the different loading and interferences the connections undergo during installation and during fracking operations.

However, P3 is normally the radial stress and is not normally subject to becoming a higher principal stress. Pin hoop stress is the main concern for a reliable thread internal pressure seal (and even metal-to-metal internal pressure seals) during the different loading throughout the well bore. Present theory is that the pin member should be in hoop compression during all loading, including during combined loading such as axial tension, or bending with and without internal pressure.

Normally, the diametrical interference required to reliably contain internal pressure will be the P1 principal stress throughout the well bore. Therefore P2, either axial tension or axial compression, can be raised to enhance the performance of the connection without raising the total von Mises stress levels within the threaded region (as shown in FIGS. 5 and 6 as 61 and 62). In fact, it can and preferably will lower the von Mises stress levels within the threaded region.

By controlling the first two of the three principal stresses, P1, normally hoop, and P2, normally axial, within the threaded area of the connection, improvements can be made in gall resistance during assembly and during disassembly by reducing brinelling from excess loading. This results in higher make-and-break cycles. Controlling P1 and P2 greatly increases torque capacity and significantly increases sealing integrity throughout the length of the thread region. This is because the axial thread flanks will have more uniform contact and elimination of thread flank leak paths throughout the length of the thread region (see FIGS. 5 and 6), through all combined loading cycles in the well bore.

FIGS. 1 and 3 are believed to be typical examples of present-day wedge thread design teachings and believed to be in production, and known to be among the highest torque capacity connections currently on the market.

FIGS. 2 and 4 are teachings of major performance improvements due to stress control by controlling the first two of the principal triaxial stresses discussed above. Also shown is a unique method of improving the reliability of internal pressure thread sealing through control of the two primary principal stresses (P1 and P2) so the sealing integrity will improve substantially and remain sufficient during installation and fracking operations and throughout the installation process and subsequent production through the well bore. In addition, torque capacity can be increased by as much as 100% without damaging the threads. Further, axial compression or axial tension capacity of the connection can be increased substantially. This permits the installation of a much longer tubular member in the horizontal section shown as 65 in FIG. 7 or even a longer tubular member in the vertical section shown as 64 in FIG. 7.

FIGS. 5 and 6 show the thread region areas that are the subject of this invention. The area 61 is a two-step thread region. The area 62 is a one-step thread region. As has been briefly discussed, FIG. 7 shows the basic design of a shale well bore. The region 63 is the transition zone. The region 64 is the vertical zone and region 65 is the horizontal zone.

### Example 1

FIG. 1 is a typical example of a one-step tapered symmetric connection showing axial dimensions (1 and 3 in FIG. 1) referenced from the origin position 9 that is determined by the person creating the design to meet the criteria desired. Also shown are the axial tension flanks (load flanks, 5 and 7) and the axial compression flanks (stab flanks, 6 and 8). In addition, the illustration shows a male (pin) member 10 and a female (box) member 11. Also shown is a tooth width (2 in FIG. 1) on the pin member and a mating groove width 4 on the box member.

In this example, principal stress P1 is generally the hoop stress required to contain internal pressure, it being understood that the pin is to be in hoop compression during the fracking loads throughout the well bore. This ensures that the roots and crests will stay together (closed) during all loading circumstances throughout the length of the well bore. When P1 is initially established, it should be fixed at basically the lowest diametrical stress level necessary to seal internal pressure. However, the load flank and stab flank helical leak paths require that axial principal stress P2 is sufficient to ensure consistent and uniform flank engagement throughout the thread region shown as 62 in FIG. 6.

Typically, tooth width 2 is wider than groove width 4. This becomes the thread width interference 30 and is used to set a desired torque. However, if the interference is too great, the threads will brinell and gall and greatly hinder the assembly and disassembly of the connection. This excess thread interference situation reduces the reliability of the thread seal and typically fails intermittently during physical testing. The axial dimensions 1 and 3 are the same nominal dimension, neglecting thread width interference.

In this typical configuration there is little or no control of P2 stresses and this will result in gaps opening between the flanks in certain areas and the loss of uniform contact in other areas and this will occur throughout the length of the connection. These gaps must be plugged by thread compound to prevent leaking from internal pressure. Unfortunately, while the pipe string is being rotated as it transitions from vertical to horizontal as shown in FIG. 7 as 63, the pipe and connections are subjected to bending loads with rotation. During this rotation/bending, the stab flanks and load flanks cycle from higher loads to lower loads while being rotated. If the flanks had gaps between them with thread compound filling the gaps, the compound will be squeezed away as the gaps close during the cycling. With further rotation, the chance of the thread compound moving back to the gap is not assured, basically because this rotational open/close function will act more like a pump, forcing the thread compound out of the connection with it not being able to return.

### Example 2

FIG. 2 is an example of a one-step tapered asymmetric connection of the invention which features unique control of the thread flanks by intentionally not pre-establishing the thread widths at a fixed distance from a reference point. All axial dimensions 12, 13, 14 and 15 are determined from the axial origin 20. Axial dimensions 12 and 14 are considerably different from the theoretical interference required for torque resistance. The Pin is numbered as 21 and box as 22. Numbers 17 and 19 are mating stab flanks. Numbers 16 and 18 are the mating loads flanks.

In this example, P1 is the hoop stress required to contain internal pressure and for the pin to be in hoop compression during the fracking loads throughout the well bore. This ensures that the roots and crests will stay in contact during all loading circumstances throughout the length of the well bore. However, closing the load flank and stab flank helical leak paths requires the P2 axial stress to ensure consistent and uniform flank engagement throughout the length of the connection.

Mating axial dimensions 12 and 14 are considerably different to help control axial P2 stress. The dimension 12 is asymmetrically longer than 14. (Theoretical interference visualized in machined state). Mating axial dimensions 13 and 15 are considerably different to help control axial P2 stress. The dimension 13 is asymmetrically longer than 15. (Theoretical axial gap visualized in machined state.) Any gap between 13 and 15 will close and the mating surfaces will gain interference during assembly. Engagement of load flanks 12 and 14 creates an axial stress within the thread region and, as shown in FIGS. 5 and 6, lowers the von Mises stress.

In contrast, FIG. 1 shows interference on both stab and load flanks as visualized in the machined state so the P2 axial stress does not lower the von Mises stress in the thread region shown as 62 in FIG. 6.

This creates reliable thread sealing and is believed to be more reliable than a metal-to-metal seal because the thread forms lock the connection together radially, the pin is in hoop compression, and the thread flanks are not separating during the loading throughout the length of the well bore. Also, with the threads having uniform contact, the connection can have higher torque resistance without brinelling and galling. This example is of a more robust connection than that depicted in FIG. 1.

### Example 3

FIG. 3 is a typical example of a two-step tapered symmetric connection showing similar positioning to its axial origin 39 as in FIG. 1 to its axial origin 9. Load flanks 23, 25, 27, and 29 are positioned to the origin 39. Then pin thread tooth widths 24 and 26 are determined by comparing them with mating box thread groove widths 28 and 30. The pin member is numbered as 40 and box member as 41. The stab flanks are shown as 36, 38, 32, and 34. The load flanks are shown as 35, 37, 31, and 33. In FIG. 3, in thread region 61, there is slightly greater control of P2 stresses than in FIG. 1, thread region 62. The reason is because the connection is divided into two parts with two mating steps. There is no change to the P1 hoop stress so the roots and crests maintain sealing integrity. The thread width 24 is wider than groove width 28. The thread width 26 is wider than groove width 30.

These are adjusted in width to achieve the desired torque setting. However, if the interference is too great the threads will brinell and gall, greatly hindering the assembly and disassembly of the connection. This condition reduces the reliability of attaining a thread seal. A major benefit of the connection having two-steps is that the thread flanks will have more uniform contact and therefore higher torque resistance. However, the possibility of brinelling will limit the maximum torque rating. Also, the connection of FIG. 3 will have slightly greater sealing integrity than the connection of FIG. 1. Load flanks at 23 and at 27 have basically the same dimension from the axial origin, neglecting thread width interference. Load flanks at 25 and 29 have basically the same dimension from the axial origin, neglecting thread width interference.

### Example 4

FIG. 4 is an example of the unique positioning of the thread flanks by intentionally not pre-establishing the thread widths at a fixed distance from a reference point. FIG. 4 represents even more control of P2 than possible in FIG. 2 because the separation between the two steps increases the number of locations where control of the axial stresses within the connection configuration can be established through the manipulation of distances from those locations and the origin position 58. Dimension 58 is the line of axial origin. Dimensions 50, 54, 52 and 56 are axial tension flanks (load flanks). Dimensions 51, 55, 53, and 57 are axial compression flanks (stab flanks). Reference number 60 is the box and reference number 59 is the pin. Line 58 is the origin position for the axial dimensions.

Load flanks 48 and 44 are mating large step load flanks dimensioned from origin 58. Load flanks 46 and 42 are mating small step load flanks dimensioned from origin 58. Stab flanks 49 and 45 are mating large step stab flanks dimensioned from origin 58. Stab flanks 47 and 43 are mating small step stab flanks dimensioned from origin 58. Load flank 48 is considerably longer than load flank 44 (theoretical axial gap visualized in machined state). Connection make-up is possible only because of pin and box member elasticity. Stab flank 49 is considerably longer than stab flank 45 (theoretical axial interference visualized in machined state) but there is not as much difference as between 48 to 44. The dimension 46 is considerably longer than 42 (theoretical axial gap visualized in machined state) but there is not a greater difference than either 48 to 44 or 49 to 45. The dimension 47 is considerably longer than 43 (theoretical axial interference visualized in machined state) and there is more difference than 46 to 42.

Altering the distances 48, 44, 49, 45, 46, 42, 47, and 43 can be done to manipulate and control P2 axial stresses in the thread zone and lower the von Mises stress within the thread zone. Also, this two-step configuration allows the increased control of the von Mises stress in the thread region 61 (shown in FIG. 5) over the thread region of FIG. 2 because there are double the positions to manipulate.

This P2 stress control will increase uniform contact of stab and load flanks, increase the torque resistance without brinelling, increase the uniform load and stab flanks contact while bending in the transition zone 63 shown in FIG. 7 (with and without internal pressure), and increase the reliability of the primary thread seal throughout the combined loads of the well bore. It will also increase the fatigue resistance of each connection through the transition zone, and increase axial compression capacity needed for extended reach horizontal sections, and increase the possibility of having interchangeability between different connections for pipes of a given pipe diameter.

While the invention has been described in one preferred form, it will be appreciated that the axial positions from the origins may be reversed, depending on the box and pin weakness being addressed, and whether axial tension or axial compression is of greater importance in the particular application.

It will be appreciated from the foregoing discussion, and as illustrated in the foregoing examples, a central concept of the designs of the invention is the fact that the pin connector is intentionally made to be asymmetric to the box. Previous connectors have been designed to be symmetric in order to induce interference needed to induce torque and to hold internal pressure, so that the box is, in effect, a mirror image of the pin. In the connection of the invention, however, the designers intentionally make one member to be asymmetric with respect to the other member in the thread axial direction.

The amount of offset is an unknown number until extensive finite element analyses, usually in three dimensions, are run. Axial offsets are induced until the triaxial stresses are minimized in the threads, around the complete VME envelope for the connection. In a two-step connection, it is typical for the lower step to have a different offset than the upper step. To the typical thread designer, it would appear that a connector designed according to these principles could never be made up without galling and binding. The fact that such a design can be realized is thus testimony to the non-obvious and novel nature of the design. How this exactly occurs is the result of a number of factors. Taking one factor as an example, the elasticity in the steel of the connection allows the initial bearing loads on the mating threads to remain below yield and the loads quickly distribute as the threads are rotated together. Still, some asymmetry in loading will remain to allow the triaxial stresses in the connector to be minimized in all parts of the connector under operational loading, including full VME loading during the transition zone between horizontal and vertical as tension with torque is replaced by compression with torque.

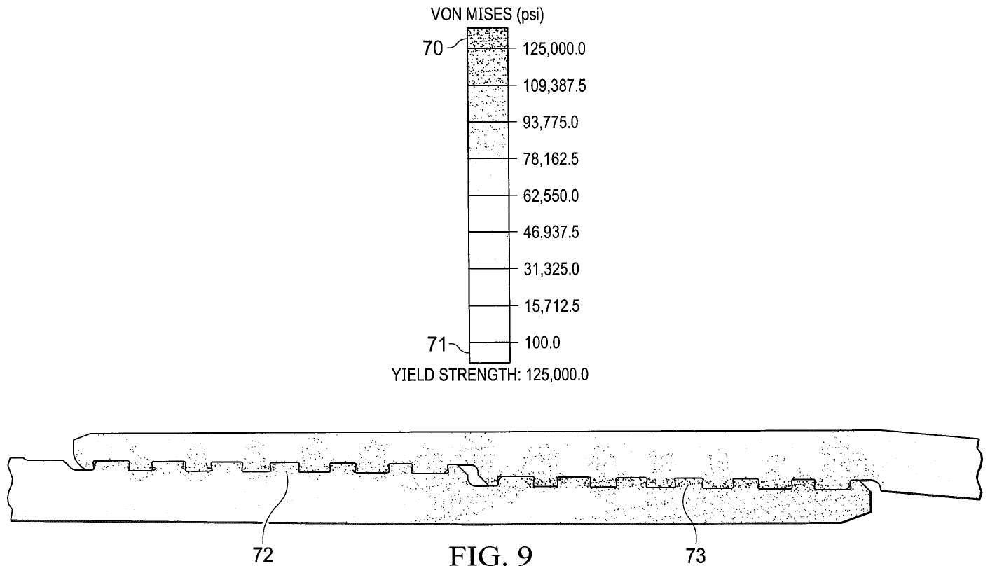

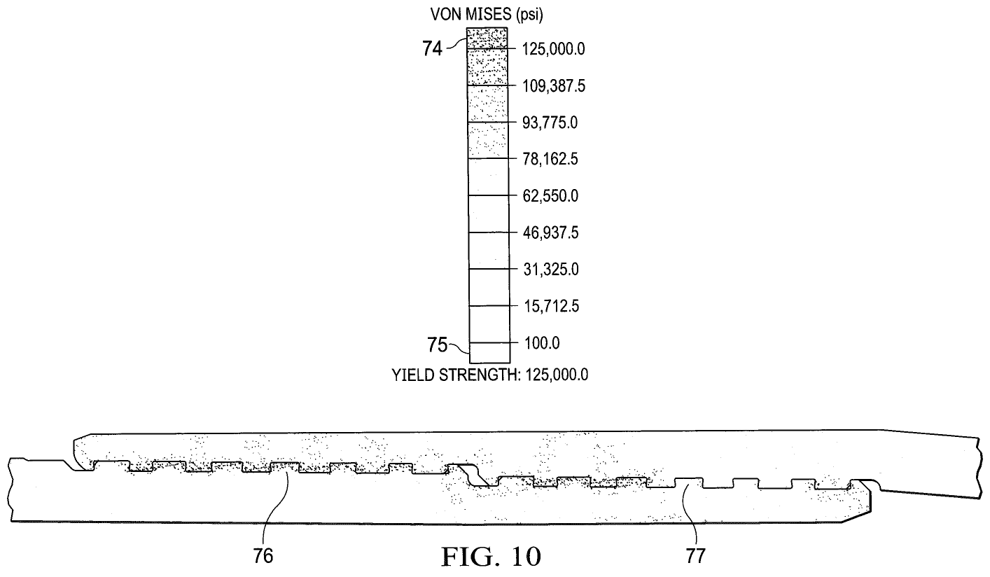

In order to further illustrate these principles, FIGS. 9-12 are actual FEA “Finite Element Analysis” examples of symmetric (FIG. 9), modified symmetric (FIGS. 10-11), and asymmetric wedge thread (FIG. 12) connections showing the von Mises stresses. All have equal diametrical interferences, so P1 will be hoop stress. P2 will be axial stress and P3 will be radial stress. The FEA examples illustrate the connection of the invention as it progressed from original design to final design.

Thus, FIG. 9 shows the connector as originally designed by the traditional design method.

FIG. 12 shows the connector in its final form, having been designed by the asymmetric design method.

FIGS. 10 and 11 represent intermediate design steps in which the thread designers explored ways to overcome the design deficiencies of the connection of FIG. 9, namely the lack of sufficient sealing ability.

FIG. 9 is a symmetric design, similar to FIG. 3, showing the FEA von Mises results. The darker shading upwards on the chart toward 70 on the scale is the higher von Mises stress while the lighter shading lower on the chart toward 71 is lower stress. The region 72 is what is called the large diameter step, while 73 constitutes the small diameter step. Both the large and small diameter steps are showing very high stresses in the thread profile regions. These stresses lead to high hoop P1 stresses and low axial P2 stresses.

FIG. 10 is a modified symmetric design showing the FEA von Mises results. The darker shading upwards on the chart towards 74 is the higher von Mises stress while the lighter shading lower on the chart towards 75 is lower stress. The region 76 is what is called the large diameter step and the region is the small diameter step. The large diameter step is showing very high stress in the thread profile region, higher stress than in the large diameter step on FIG. 9, but lower stress than in the small diameter step on the FIG. 9 small diameter step. The difference between the illustrations shown in FIGS. 9 and 10 is that the distance between the steps is lengthened, resulting in the increase of the axial P2 stress. However, the load flanks and stab flanks do not have a uniform contact throughout the length of the connection, possibly creating a leak path during cyclic loading. One attribute of this modification is that the torque range will be increased over FIG. 9.

FIG. 11 is another modified symmetric design showing the FEA von Mises results. The darker shading upwards on the chart toward 78 is the higher von Mises stress while the lighter shading lower on the chart toward 79 is lower stress. The region 80 is what is called the large diameter step and 81 is the small diameter step. The large diameter step is showing high stresses in the thread profile region, but lower stress than in FIGS. 9 and 10, and also lower stress than in FIGS. 9 and 10 in the small step. The difference between the illustrations shown in FIGS. 10 and 11 is that the distance between the steps is shortened to be less than that on FIG. 9, resulting in the same equivalent axial P2 stress, although opposite in axial origin. However, the load flanks and stab flanks still do not have a uniform contact throughout the length of the connection, possibly creating a leak path during cyclic loading. One attribute of this modification is that the torque range will be increased over FIG. 10.

FIG. 12 is the asymmetric design of the invention, similar to FIG. 4, showing the FEA von Mises results. The darker shading upwards on the chart toward 82 is the higher von Mises stress while the lighter shading lower on the chart toward 83 is lower Stress. The region 84 is what is called the large diameter step and 85 is the small diameter step. The large diameter step is not showing high stress in the thread profile region as it did in FIGS. 9-11, and the small step is not showing as high a stress in the thread profile region as in FIGS. 9-11. These von Mises stresses are lower due to the higher axial P2 stresses imparted on make-up as a result of the asymmetric design. One attribute of this design is that the torque range will be increased over that of illustrations 9, 10 or 11.

In the connection shown in FIG. 9, the design effort was primarily focused on keeping the thread flanks fully engaged on the small diameter step throughout the VME test cycle. The designers were able to change the thread loading by offsetting the small step axially through greater step separation on one member. All threads were separated equally and the thread widths were not changed. It was the traditional design, just with an offset. Stresses were not balanced but the connection was able to hold pressure.

Further efforts to keep all the threads fully engaged axially throughout the VME test cycle led to the connector illustrated as FIG. 10 above where, instead of separating the steps axially, the designers went in the opposite direction and forced the threads together by reducing the separation between the two steps. There were both advantages and disadvantages to this approach but it was clear that stresses in the threads remained completely uneven and unbalanced.

It was after struggling with these issues that the designs realized the present inventive concept of using repetitive FEA analyses to determine how to preload each thread throughout its length in order to get a completely balanced and uniform triaxial stress in every portion of the thread and to then change the thread width reference point to effect those results. This directly led to the discovery of the asymmetric design concept as described in the present specification.

An invention has been provided with several advantages. An improved wedge thread connection is shown, useful for oil and gas well tubing, casing and drill pipe in which a female connector is assembled with an asymmetric male connector. The pin connector is intentionally made asymmetric to the box. The result is a unique method of improving the reliability of internal pressure thread sealing through control of the two primary principal stresses (P1 and P2) so that the sealing integrity will improve substantially and remain sufficient during installation and fracking operations and throughout the installation process and subsequent production through the well bore. In addition, torque capacity can be increased by as much as 100% without damaging the threads. Further, axial compression or axial tension capacity of the connection can be increased substantially. This permits the installation of a much longer tubular member in the horizontal section of the well bore or even a longer tubular member in the vertical section of the well bore. The asymmetrical connector designs of the invention should result in improved sealing over the length of the connection without requiring a metal-to-metal seal. It is believed that elimination of the metal-to-metal seal feature will greatly reduce the manufacturing costs, typically by up to 50% or 75%. Therefore, by eliminating the metal-to-metal seal, the thread would be the primary seal. The unique configuration of this new wedge thread can and is proven to be a more reliable internal pressure seal than a metal-to-metal seal throughout the length of the well bore subjected to full loading during installation and production, and far less costly.

While the invention has been shown in several of its forms, it is not thus limited but is susceptible to various changes and modifications without departing from the spirit thereof, as described in the claims which follow.

1. A method of designing a wedge thread tubular connection for well tubing, casing and drill pipe having mating thread portions of a given length, which connection is capable of being screwed together to form a gas tight seal without the use of a metal-to-metal seal section, the method comprising the steps of:
designing a pin connector member having a pin end with an outer extent and having external threads cut over a given thread length with stab flanks and load flanks and crests and roots, constituting a thread form for the pin member;
designing a mating box connector member with a box end having internal threads cut over a given thread length with stab flanks and load flanks and crests and roots, constituting a thread form for the box member, for mating with the external threads of the pin member to make up the threaded connection;
wherein the thread form of the pin member is intentionally designed to be asymmetric to that of the box member, the pin thread form being offset in a thread axial direction by a predetermined amount, thereby allowing triaxial stresses in the connection to be minimized along an entire length of the threaded connection in use; and
wherein the thread offset is increased until triaxial stresses are minimized in the threads around a complete VME envelope for the connection, including a full VME loading cycle during a transition zone between horizontal and vertical, as tension with torque is replaced by compression with torque.

2-3. (canceled)

4. The method of designing a wedge thread tubular connection of Claim 1, wherein for a two-step tubular connection having an upper step and a lower step, the lower step has a different flank offset from the upper step.

5-14. (canceled)

15. A method of designing a wedge thread tubular connection for well tubing, casing and drill pipe having mating thread portions of a given length, which connection is capable of being screwed together to form a gas tight seal without the use of a metal-to-metal seal section, the connection comprising:
designing a pin connector member having a pin end with an outer extent and having external threads cut over a given thread length with stab flanks and load flanks and crests and roots, constituting a thread form for the pin connector member;
designing a mating box connector member with a box end having internal threads cut over a given thread length with stab flanks and load flanks and crests and roots, constituting a thread form for the mating box connector member, for mating with the external threads of the pin connector member to make up the threaded connection;
wherein the thread flanks of one of the connector members is designed to be asymmetric to that of the other respective mating connector member, the mating thread flanks of the pin connector member and the mating thread flanks of the box connector member both being initially located at a selected distance from a common axial point of origin which can be used to define a thread length reference point;
wherein the pin and box threads are machined from the thread length reference points and wherein repetitive finite element analysis is used to determined how to preload each thread form throughout the entire length of the connection in order to provide balanced and uniform stress in every portion of the thread, followed by changing the selected distances from the common point of origin to achieve these results.

16. A wedge thread tubular connection for well tubing, casing and drill pipe having mating threaded portions of a given length, which connection is capable of being screwed together to form a gas tight seal without the use of a metal-to-metal seal section, the connection comprising:
designing a pin connector member having a pin end with an outer extent and having external threads cut over a given thread length with stab flanks and load flanks and crests and roots, constituting a thread form for the pin connector member;
designing a mating box connector member with a box end having internal threads cut over a given thread length with stab flanks and load flanks and crests and roots, constituting a thread form for the mating box connector member, for mating with the external threads of the pin connector member to make up the threaded connection;
wherein the thread flanks of one of the connector members is designed to be asymmetric to that of the other respective mating connector member, the mating thread flanks of the pin connector member and the mating thread flanks of the box connector member both being initially located at a selected distance from the same common axial point of origin which defines a thread length reference point;
wherein the selected distances from the common axial point of origin are subsequently varied to provide different thread length reference points based upon trial and error coupled with repetitive finite element analysis to arrive at final thread length reference points defined from the same common axial point of origin, the repetitive finite element analysis being used to determine the final amount of asymmetry required between the mating thread flanks to achieve uniform axial contact of the thread flanks throughout the entire length of the threaded portion of the connection once the connection is made up and thereby provide a gas tight seal.

17. The method of designing a wedge thread tubular connection of claim 16, wherein for a two-step tubular connection having an upper step and a lower step, both steps flanks are tied separately to the common point of origin.

18. The method of designing a wedge thread tubular connection of claim 16, wherein the tubular connection is designed so that there is no gap between the mating pin and box thread flanks after connection is made up.

19. The method of designing a wedge thread tubular connection of claim 16, wherein repeated finite element analysis is used to determine the amount of asymmetry required to overcome the natural elasticity of the pipe in use, offsetting the pipe elasticity with sufficient asymmetry to keep all the thread flanks in contact along the entire length of the connection.

20. The method of designing a wedge thread tubular connection of claim 16, wherein a common axial point of origin applies to each mating thread, all subsequent design points axially and radially being then tied back to the common axial origin point.
